(19) United States
(12) Patent Application Publication
(10) Pub. No.: US 2022/0400127 A1
(43) Pub. Date: Dec. 15, 2022

(54) ANOMALOUS USER ACTIVITY TIMING DETERMINATIONS

(71) Applicant: Microsoft Technology Licensing, LLC, Redmond, WA (US)

(72) Inventors: Idan Yehoshua HEN, Tel Aviv (IL); Itay ARGOETY, Tel Aviv (IL); Idan BELAIEV, Tel Aviv (IL)

(73) Assignee: Microsoft Technology Licensing, LLC, Redmond, WA (US)

(21) Appl. No.: 17/343,684

(22) Filed: Jun. 9, 2021

(51) Int. Cl. H04L 29/06; G06N 20/00; G06F 11/34

(52) U.S. Cl. CPC H04L 63/1425; G06N 20/00; G06F 11/3438

(57) ABSTRACT

According to examples, an apparatus may include a processor and a memory on which is stored machine-readable instructions that when executed by the processor, may cause the processor to identify a timing at which a user activity occurred and may apply an anomaly detection model on the identified timing at which the user activity occurred, in which the anomaly detection model is to output a risk score corresponding to a deviation of the timing at which the user activity occurred from timings at which the user normally performs user activities. The processor may also determine whether the timing at which the user activity occurred is anomalous based on the risk score and, based on a determination that the timing at which the user activity occurred is anomalous, may output an alert regarding the anomalous timing of the user activity occurrence.

### BACKGROUND

Many organizations may employ anomaly detection techniques to identify actions that may potentially be malicious. For instance, the anomaly detection techniques may be employed to identify malware such as denial of service attacks, viruses, ransomware, and/or spyware. Once malware is identified, remedial actions may be employed to mitigate harm posed by the malware as well as to prevent the malware from spreading further.

### BRIEF DESCRIPTION OF DRAWINGS

Features of the present disclosure are illustrated by way of example and not limited in the following figure(s), in which like numerals indicate like elements, in which:

FIG. 1 shows a block diagram of a network environment, in which an apparatus may determine whether a timing at which a user activity occurred is anomalous and to output an alert based on a determination that the timing is anomalous, in accordance with an embodiment of the present disclosure;

FIG. 2 depicts a block diagram of the apparatus depicted in FIG. 1, in accordance with an embodiment of the present disclosure;

FIGS. 3 and 4, respectively, depict flow diagrams of methods for determining whether a timing at which a user activity occurred is anomalous and outputting an alert based on a determination that the timing is anomalous, in accordance with an embodiment of the present disclosure; and

FIG. 5 shows a block diagram of a computer-readable medium that may have stored thereon computer-readable instructions for determining whether features pertaining to an interaction event are anomalous and to output a notification based on a determination that the features are anomalous, in accordance with an embodiment of the present disclosure.

### DETAILED DESCRIPTION

For simplicity and illustrative purposes, the principles of the present disclosure are described by referring mainly to embodiments and examples thereof. In the following description, numerous specific details are set forth in order to provide an understanding of the embodiments and examples. It will be apparent, however, to one of ordinary skill in the art, that the embodiments and examples may be practiced without limitation to these specific details. In some instances, well known methods and/or structures have not been described in detail so as not to unnecessarily obscure the description of the embodiments and examples. Furthermore, the embodiments and examples may be used together in various combinations.

Throughout the present disclosure, the terms “a” and “an” are intended to denote at least one of a particular element. As used herein, the term “includes” means includes but not limited to, the term “including” means including but not limited to. The term “based on” means based at least in part on.

Disclosed herein are apparatuses, methods, and computer-readable media in which a processor may determine whether a timing at which an user activity occurred is anomalous (or equivalent, abnormal). Based on a determination that the timing of the user activity occurrence is anomalous, the processor may output an alert regarding the anomalous timing of the user activity occurrence. Particularly, for instance, the processor may apply an anomaly detection model on the identified timing at which the user activity occurred, in which the anomaly detection model may output a risk score corresponding to a deviation of the timing at which the user activity occurred from timings at which the user normally performs user activities. The processor may determine whether the timing at which the user activity occurred is anomalous based on the risk score. In addition, the processor may, based on a determination that the timing at which the user activity occurred is anomalous, output an alert regarding the anomalous timing of the user activity occurrence.

In some examples, the processor may train the anomaly detection model, which may be a machine-learning model. The processor may train the anomaly detection model using data collected pertaining to activities of the user. In addition, or alternatively, the processor may train the anomaly detection model using data collected pertaining to activities of multiple users. In some examples, the processor may determine whether there is sufficient data collected pertaining to activities of the user for the anomaly detection model to be trained to output the risk score within a predefined level of precision. Based on a determination that there is sufficient data, the processor may apply an anomaly detection model that is trained using data collected pertaining to activities of the user to determine the risk score. However, based on a determination that there is insufficient training data, the processor may apply an anomaly detection model that is trained using data collected pertaining to activities of multiple other users to determine the risk score.

As the collected amount of activity-related data increases, the detection of anomalous activities may become increasingly difficult and may result in greater numbers of false positive indications. For instance, using a static or generic work schedule for a user as a normal timing at which activities are performed may not accurately reflect a user's normal working hours. Instead, as many people work from home and outside of conventional working hours, the normal working hours of many people may differ from each other. Thus, using a generic work schedule as a basis for determining whether activities are anomalous may result in a large number of false positive indications being determined as the activities may occur outside of the generic work schedule.

Through implementation of the features of the present disclosure, anomalous timings of user activities may accurately be detected through application of an anomaly detection model that may output a risk score corresponding to a deviation of the timing at which the user activity occurred from timings at which the user normally performs user activities. Thus, for instance, when a resource is accessed outside of a normal timing, that access may be flagged as being anomalous. In addition, as the normal timing may be determined for the user based on the user's activity, the normal timing may accurately reflect the user's normal work hours. Technical improvements afforded through implementation of the present disclosure may thus include improved anomalous user activity detection, reduced false positive detections, and/or the like, which may improve security across networked computing devices.

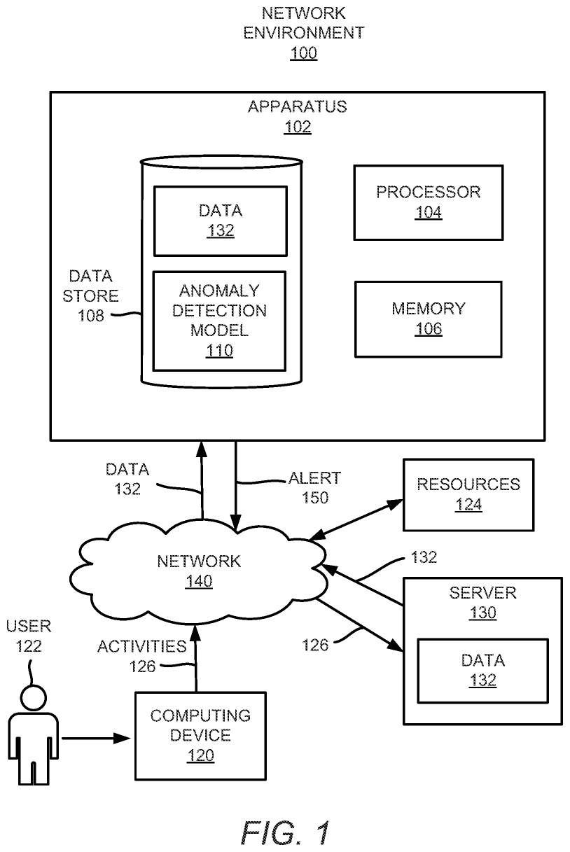

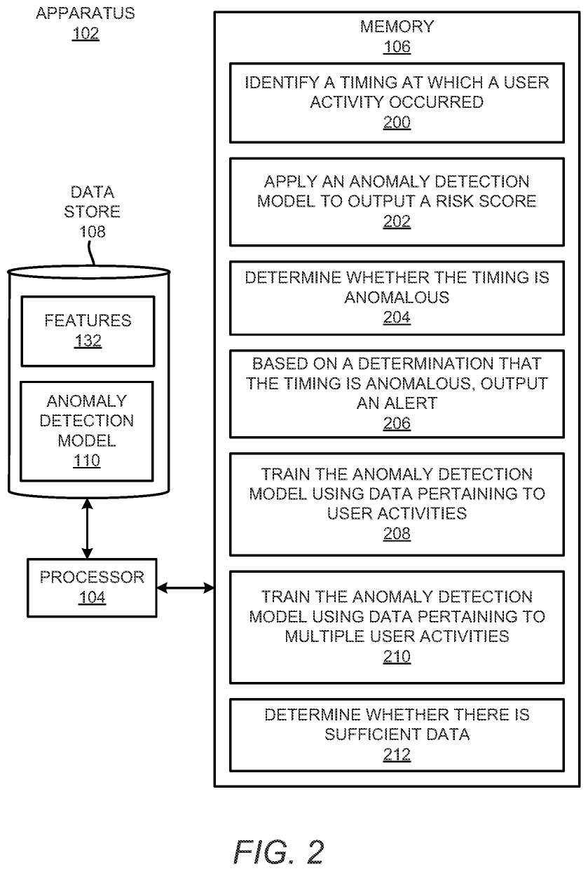

Reference is first made to FIGS. 1 and 2. FIG. 1 shows a block diagram of a network environment 100, in which an apparatus 102 may determine whether a timing at which a user activity occurred is anomalous and to output an alert 150 based on a determination that the timing is anomalous, in accordance with an embodiment of the present disclosure. FIG. 2 depicts a block diagram of the apparatus 102 depicted in FIG. 1, in accordance with an embodiment of the present disclosure. It should be understood that the network environment 100 and the apparatuses 102 may include additional features and that some of the features described herein may be removed and/or modified without departing from the scopes of the network environment 100 and/or the apparatuses 102.

As shown in FIG. 1, the network environment 100 may include the apparatus 102 and a computing device 120. The apparatus 102 may be a computing device, such as a server, a desktop computer, a laptop computer, and/or the like. The computing device 120 may be a laptop computing device, a desktop computing device, a tablet computer, a smartphone, and/or the like, that a user 122 may use to access resources 124 through a network 140. The computing device 120 may communicate with a server 130, in which the server 130 may be remote from the computing device 120. In some examples, the apparatus 102 may be a computing device that an administrator, IT personnel, and/or the like, may access in, for instance, managing operations of the server 130. By way of particular example, the apparatus 102 may be a server of a cloud services provider or an organization. It should be understood that a single apparatus 102, a single computing device 120, and a single server 130 have been depicted in FIG. 1 for purposes of simplicity. Accordingly, the network environment 100 depicted in FIG. 1 may include any number of apparatuses 102, computing devices 120, and/or servers 130 without departing from a scope of the network environment 100.

In some examples, the server 130 may track or monitor the activities 126 of the user 122 on the computing device 120. In other examples, the server 130 may collect data pertaining to the activities 126 from other any of a number of data sources. In either of these examples, the activities 126 of the user 122 may include access by the user 122 to a cloud environment, login events to a resource 124 by the user 122, access by the user 122 to resources 124, and/or the like. The resources 124 may be files, services, programs, and/or the like that the user 122 may access through the computing device 120. In some examples, any of a number of data sources may track and log the activities 126 of the user 122. The data source may include, for instance, a domain controller, a network manager, and/or the like. The computing device 120 may also track and log some of the activities 126 and may forward data pertaining to the activities 126 to the server 130 via a network 140, which may be a local area network, a wide area network, the Internet, and/or the like. By way of particular example, the user 122 may input user credentials through the computing device 120 such that the user 122 may log into a particular account, for instance, a particular user account, on the computing device 120.

The activities 126, which are also referenced herein as user activities 126, may include activities within a set of predefined activities, such as an interaction in which the user 122 logs into the computing device 120, an interaction in which the user 122 logs into and/or accesses a resource 124, an interaction in which the user 122 logs into the resource 124 via a virtual private network, a user interaction in which the user 122 enters an incorrect credential in attempting to log into the computing device 120, a user interaction in which the user 122 attempts to make an administrative change on the computing device 120, a user interaction in which the user attempts to access another computing device through the computing device 120, and/or the like. The predefined activities may be user-defined, for instance, by an administrator, an IT personnel, and/or the like.

The server 130 may collect the activities 126 that fall within the predefined activities and may store the collected information as data 132. This information may include the timing, e.g., the date and time, at which the activities 126 occurred, the IP addresses of the computing devices 120 from which the activities 126 occurred, the geographic locations of the computing devices 120 when the activities 126 occurred, and/or the like. The server 130 may also collect activities 126 of other users (not shown) and may include the collected activities 126 of the other users in the data 132.

As also shown in FIG. 1, the server 130 may communicate the data 132 to the apparatus 102 via the network 140. In some instances, the data 132, which may include data pertaining to current activities 126 that the user 122 (or other users) may have recently performed, may be construed as low fidelity signals because this data 132 may not identify an activity 126 individually as being anomalous. In other words, an analyst analyzing the data 132 alone may not determine that the activities 126 included in the data 132 are anomalous.

As shown in FIGS. 1 and 2, the apparatus 102 may include a processor 104 that may control operations of the apparatus 102. The apparatus 102 may also include a memory 106 on which data that the processor 104 may access and/or may execute may be stored. The processor 104 may be a semiconductor-based microprocessor, a central processing unit (CPU), an application specific integrated circuit (ASIC), a field-programmable gate array (FPGA), and/or other hardware device. The memory 106, which may also be termed a computer readable medium, may be, for example, a Random Access memory (RAM), an Electrically Erasable Programmable Read-Only Memory (EEPROM), a storage device, or the like. The memory 106 may be a non-transitory computer readable storage medium, where the term “non-transitory” does not encompass transitory propagating signals. In any regard, the memory 106 may have stored thereon machine-readable instructions that the processor 104 may execute.

Although the apparatus 102 is depicted as having a single processor 104, it should be understood that the apparatus 102 may include additional processors and/or cores without departing from a scope of the apparatus 102. In this regard, references to a single processor 104 as well as to a single memory 106 may be understood to additionally or alternatively pertain to multiple processors 104 and multiple memories 106. In addition, or alternatively, the processor 104 and the memory 106 may be integrated into a single component, e.g., an integrated circuit on which both the processor 104 and the memory 106 may be provided. In addition, or alternatively, the operations described herein as being performed by the processor 104 may be distributed across multiple apparatuses 102 and/or multiple processors 104.

As shown in FIG. 2, the memory 106 may have stored thereon machine-readable instructions 200-212 that the processor 104 may execute. Although the instructions 200-212 are described herein as being stored on the memory 106 and may thus include a set of machine-readable instructions, the apparatus 102 may include hardware logic blocks that may perform functions similar to the instructions 200-212. For instance, the processor 104 may include hardware components that may execute the instructions 200-212. In other examples, the apparatus 102 may include a combination of instructions and hardware logic blocks to implement or execute functions corresponding to the instructions 200-212. In any of these examples, the processor 104 may implement the hardware logic blocks and/or execute the instructions 200-212. As discussed herein, the apparatus 102 may also include additional instructions and/or hardware logic blocks such that the processor 104 may execute operations in addition to or in place of those discussed above with respect to FIG. 2.

The processor 104 may execute the instructions 200 to identify a timing at which a user activity 126 occurred. In some examples, when the user activity 126 occurs, the processor 104 may be notified of the occurrence directly from the computing device 120 or from the server 130. In other examples, the server 130 may collect and store data 132 pertaining to the user activity 126 and may forward the data 132 at set intervals of time to the apparatus 102. For instance, the server 130 may send the data 132 at predetermined time periods, every hour, once a day, once a week, etc. The predetermined time periods may be user-defined and may be based, for instance, on the urgency at which anomalous activities are to determined. In any of these examples, the processor 104 may identify the timing at which the user activity 126 occurred from the information received from the computing device 120 and/or the data 132.

The processor 104 may execute the instructions 202 to apply an anomaly detection model 110 on the identified timing at which the user activity 126 occurred. As shown in FIGS. 1 and 2, the anomaly detection model 110 may be stored in a data store 108, which may be, for example, a Random Access memory (RAM), an Electrically Erasable Programmable Read-Only Memory (EEPROM), a storage device, or the like.

The anomaly detection model 110 may be any suitable type of machine-learning model such as density-based models (e.g., K-nearest neighbor, local outlier factor, isolation forest, etc.), cluster-analysis-based anomaly detection models, a data clustering anomaly detection model, neural networks, and/or the like. In any of these examples, the anomaly detection model 110 may be trained using historical data to identify timings at which the user 122 normally performs user activities 126. In addition, the anomaly detection model 110 may determine and output a risk score of the identified timing of the user activity 126. The risk score may correspond to a deviation of the timing at which the user activity 126 occurred from timings at which the user 122 normally performs user activities 126. In some examples, the risk score may be relatively higher for relatively greater deviations of the user activity 126 timing from the timings at which the user 122 normally performs the user activities 126.

The timings at which the user 122 normally performs the user activities 126 may include, for instance, the timings at which the user 122 normally logs into the computing device 120, normally accesses the resources 124, and/or the like. In one regard, the timings at which the user 122 normally performs the user activities 126 may be dynamic, e.g., may change over time, may differ for different days of the week, and/or the like. In some examples, the timings at which the user 122 normally performs the user activities 126 may be construed as the normal working hours of the user 122 and may be learned from historical data. For instance, the timings at which the user normally performs the user activity may be time periods during which the user historically performs work duties for an organization. In addition, the timings at which the user 122 normally performs the user activities 126 may vary from the timings at which another similar user normally performs the user activities 126.

The processor 104 may execute the instructions 204 to determine whether the timing at which the user activity 126 occurred is anomalous based on the risk score outputted by the anomaly detection model 110. For instance, the processor 104 may determine whether the risk score exceeds a predefined threshold value. The predefined threshold value may define a value at which a timing of a user activity 126 may likely be anomalous or not. In some examples, the predefined threshold value may be determined through testing, e.g., through a determination of historical risk scores that resulted in anomalous activities. In addition, or alternatively, the predefined threshold value may be determined through modeling, simulations, and/or the like. As a yet further example, the predefined threshold value may be user defined and may vary for different users 122.

The processor 104 may execute the instructions 206 to, based on a determination that the timing at which the user activity 126 occurred is anomalous, output an alert 150 regarding the anomalous timing of the user activity 126 occurrence. The processor 104 may output the alert 150 to an administrator of an organization within which the user 122 of the computing device 120 may be a member, e.g., an employee, an executive, a contractor, and/or the like. In addition, or alternatively, the processor 104 may output the alert 150 to an administrator, IT personnel, analyst, and/or the like, such that the user activity 126 (or other activities performed through the computing device 120) may be further analyzed to determine whether a potentially malicious activity has occurred.

In some examples, the anomaly detection model 110 may be trained using data 132 collected pertaining to activities 126 of the user 122. In these examples, the anomaly detection model 110 may be trained specifically for the user 122. As discussed herein, the data 132 collected pertaining to the activities 126 of the user 122 may include data collected across multiple data sources. The multiple data sources may include a data source that tracks access to a cloud environment, a data source that tracks login events to resources, a data source that tracks access to files, and/or the like.

In other examples, the anomaly detection model 110 may be trained using data 132 collected pertaining to activities of multiple users, e.g., users of an organization to which the user 122 is a member. This data 132 may or may not include data pertaining to activities 126 of the user 122. In these examples, the anomaly detection model 110 may be trained for multiple users, e.g., for a broader range of users, for a global set of users, for users in a particular group of an organization, and/or the like. The data 132 collected pertaining to the activities 126 of the multiple users may include data collected across multiple data sources for the multiple users. The multiple data sources may include a data source that tracks access to a cloud environment, a data source that tracks login events to resources 124, a data source that tracks access to files, and/or the like. In addition, the multiple other users may include other users within an organization to which the user 122 belongs or other users within a department of the organization to which the user 122 is a member. For instance, the user 122 may be a member of the finance department of an organization and the other users may also be members of the finance department.

According to examples, a processor other than the processor 104 may train the anomaly detection model 110 using the data 132. In other examples, the processor 104 may execute the instructions 208 to train the anomaly detection model 110 using the data collected pertaining to the user activities 126. In addition, or alternatively, the processor 104 may execute the instructions 210 to train the anomaly detection model 110 using data collected pertaining to multiple user activities. That is, the processor 104 may execute the instructions 210 to train the anomaly detection model 110 using data collected pertaining to the users in multiple departments of an organization or using data collected pertaining to the users in a department of the organization to which the user 122 is a member.

In some examples, the processor 104 may execute the instructions 212 to determine whether there is sufficient data collected pertaining to activities 126 of the user 122 for the anomaly detection model 110 to be trained to output the risk score within a predefined level of precision. For instance, the processor 104 may determine whether at least a predetermined number of activities 126 pertaining to the user 122 have been collected, in which the predetermined number of activities 126 may be user-defined, determined based on simulations, determined based on testing, and/or the like. Based on at least the predetermined number of activities 126 pertaining to the user 122 have been collected, the processor 104 may determine that there is sufficient data collected pertaining to activities 126 of the user 122 for the anomaly detection model 110 to be trained to output the risk score within a predefined level of precision. The processor 104 may determine that there is sufficient data when, for instance, the user 122 has been employed with the organization for at least a predefined length of time, e.g., one month, one quarter, and/or the like.

However, based on less than the predetermined number of activities 126 pertaining to the user 122 having been collected, the processor 104 may determine that there is insufficient data collected pertaining to activities 126 of the user 122 for the anomaly detection model 110 to be trained to output the risk score within a predefined level of precision. For instance, the processor 104 may determine that there is insufficient data when, for instance, the user 122 has been employed with the organization for less than a predefined length of time, e.g., one month, one quarter, and/or the like.

Based on a determination that there is sufficient data 132 collected pertaining to the user 122, the processor 104 may apply an anomaly detection model 110 that is trained using data collected pertaining to activities 126 of the user 122 to determine the risk score. In some examples, the processor 104 may train the anomaly detection model 110 using data collected pertaining to activities 126 of the user 122.

Based on a determination that there is insufficient data 132 collected pertaining to the user 122, the processor 104 may apply an anomaly detection model 110 that is trained using data collected pertaining to activities 126 of the multiple users to determine the risk score. In some examples, the processor 104 may train the anomaly detection model 110 using data collected pertaining to activities 126 of the multiple users.

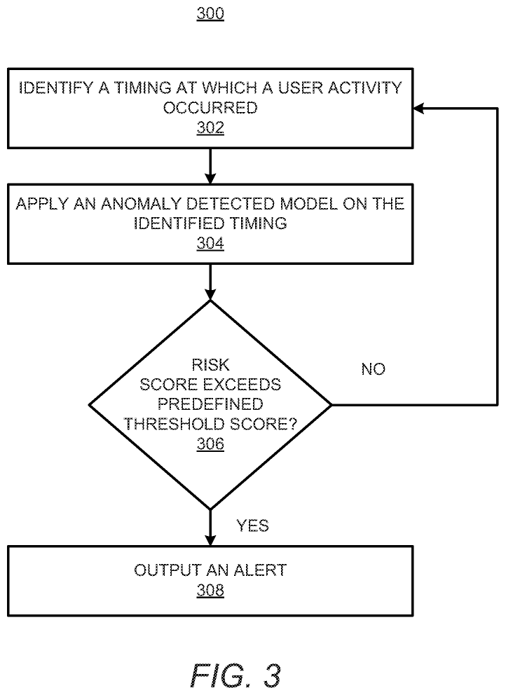

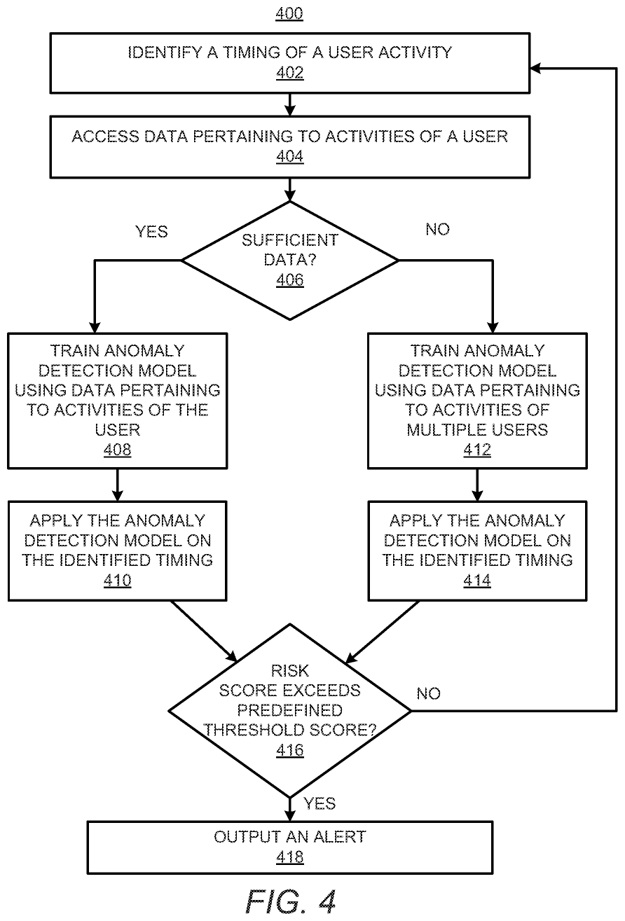

Various manners in which the processor 104 of the apparatus 102 may operate are discussed in greater detail with respect to the methods 300 and 400 depicted in FIGS. 3 and 4. Particularly, FIGS. 3 and 4, respectively, depict flow diagrams of methods 300, 400 for determining whether a timing at which a user activity 126 occurred is anomalous and outputting an alert 150 based on a determination that the timing is anomalous, in accordance with an embodiment of the present disclosure. It should be understood that the methods 300 and 400 may include additional operations and that some of the operations described therein may be removed and/or modified without departing from the scopes of the methods 300 and 400. The descriptions of the methods 300 and 400 are made with reference to the features depicted in FIGS. 1 and 2 for purposes of illustration.

With reference first to FIG. 3, at block 302, the processor 104 may identify a timing at which a user activity 126 occurred. At block 304, the processor 104 may apply an anomaly detection model 110 on the identified timing at which the user activity 126 occurred. As discussed herein, the anomaly detection model may take the identified timing as an input and may output a risk score of the timing at which the user activity 126 occurred. The risk score may correspond to a deviation of the timing of the user activity 126 occurrence from timings of normal user activities.

At block 306, the processor 104 may determine whether the risk score of the timing exceeds a predefined threshold score. Based on a determination that the timing exceeds the predefined threshold score, at block 308, the processor may output an alert 150 regarding an abnormal timing of the user activity occurrence. However, based on a determination that the timing does not exceed the predefined threshold score at block 306, the processor 104 may not output an alert 150. In addition, the processor 104 may identify a timing at which another user activity 126 occurred at block 302. The processor 104 may also repeat blocks 302-308.

Turning now to FIG. 4, at block 402, the processor 104 may identify a timing at which a user activity 126 occurred. At block 404, the processor 104 may access data 132 pertaining to activities 126 of the user 122. For instance, the processor 104 may access data 132 collected across multiple data sources over a period of time. At block 406, the processor 104 may determine whether there is sufficient data 132 collected pertaining to activities 126 of the user 122 for an anomaly detection model 110 to be trained to output a risk score that is within a predefined level of precision. For instance, the processor 104 may determine whether the user 122 has worked for an organization for a sufficient length of time for there to be sufficient data for an anomaly detection model 110 to be accurately trained.

Based on a determination that there is sufficient data 132 pertaining to activities 126 of the user 122, at block 408, the processor 104 may train the anomaly detection model 110 using the data 132 pertaining to activities 126 of the user 122. In addition, at block 410, the processor 104 may apply the anomaly detection model 110 trained at block 408 on the identified timing at which the user activity 126 occurred. As discussed herein, the anomaly detection model 110 is to take the identified timing as an input and to output a risk score of the timing at which the user activity 126 occurred corresponding to a deviation of the timing of the user activity occurrence from timings of normal user activities.

However, based on a determination that there is insufficient data pertaining to activities 126 of the user 122, at block 412, the processor 104 may train the anomaly detection model 110 using data pertaining to activities of multiple users. In addition, at block 414, the processor 104 may apply the anomaly detection model 110 trained at block 412 on the identified timing at which the user activity 126 occurred. As discussed herein, the anomaly detection model 110 is to take the identified timing as an input and to output a risk score of the timing at which the user activity 126 occurred corresponding to a deviation of the timing of the user activity occurrence from timings of normal user activities.

Following either of blocks 410 and 414, at block 416, the processor 104 may determine whether the risk score of the timing exceeds a predefined threshold score. Based on the risk score of the timing exceeding the predefined threshold score, at block 418, the processor 104 may output an alert 150 regarding an abnormal timing of the user activity 126 occurrence. However, based on a determination that the timing does not exceed the predefined threshold score at block 416, the processor 104 may not output an alert 150. In addition, the processor 104 may identify a timing at which another user activity 126 occurred at block 402. The processor 104 may also repeat blocks 402-418.

Some or all of the operations set forth in the methods 300, 400 may be included as utilities, programs, or subprograms, in any desired computer accessible medium. In addition, the methods 300, 400 may be embodied by computer programs, which may exist in a variety of forms both active and inactive. For example, they may exist as machine-readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

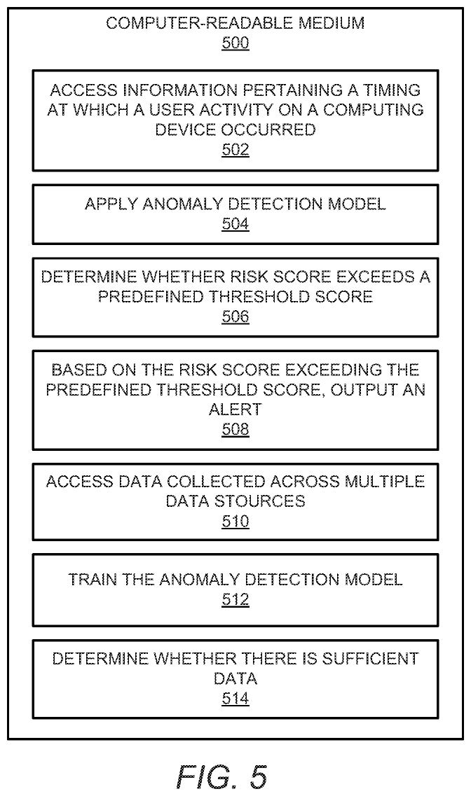

Turning now to FIG. 5, there is shown a block diagram of a computer-readable medium 500 that may have stored thereon computer-readable instructions to determine whether a timing at which a user activity 126 occurred is anomalous and to output an alert 150 based on a determination that the timing is anomalous, in accordance with an embodiment of the present disclosure. It should be understood that the computer-readable medium 500 depicted in FIG. 5 may include additional instructions and that some of the instructions described herein may be removed and/or modified without departing from the scope of the computer-readable medium 500 disclosed herein. The computer-readable medium 500 may be a non-transitory computer-readable medium, in which the term “non-transitory” does not encompass transitory propagating signals.

The computer-readable medium 500 may have stored thereon computer-readable instructions 502-514 that a processor, such as a processor 104 of the apparatus 102 depicted in FIGS. 1 and 2, may execute. The computer-readable medium 500 may be an electronic, magnetic, optical, or other physical storage device that contains or stores executable instructions. The computer-readable medium 500 may be, for example, Random Access memory (RAM), an Electrically Erasable Programmable Read-Only Memory (EEPROM), a storage device, an optical disc, and the like.

The processor may fetch, decode, and execute the instructions 502 to access information pertaining to a timing at which a user activity 126 on a computing device 120 occurred. The processor may fetch, decode, and execute the instructions 504 to apply an anomaly detection model 110 on the timing at which the user activity 126 on the computing device 120 occurred. The anomaly detection model 110 may take the identified timing as an input and may output a risk score of the timing at which the user activity 126 occurred corresponding to a deviation of the timing of the user activity occurrence from timings during which the user 122 historically performs work duties of an organization to which the user 122 is a member.

The processor may fetch, decode, and execute the instructions 506 to determine whether the risk score of the timing exceeds a predefined threshold score. The processor may fetch, decode, and execute the instructions 508 to, based on the risk score of the timing exceeding the predefined threshold score, output an alert 150 regarding the risk score of the timing of the user activity 126 occurrence.

In some examples, the processor may fetch, decode, and execute the instructions 510 to access data 132 collected across multiple data sources. The processor may fetch, decode, and execute the instructions 512 to train the anomaly detection model 110 using the accessed data 132. In some examples, the processor may fetch, decode, and execute the instructions 514 to determine whether there is sufficient data 132 pertaining to activities of the user 122 for the anomaly detection model 110 to be trained to output the risk score within a predefined level of precision. Based on a determination that there is sufficient data 132 pertaining to activities 126 of the user 122, the processor may train the anomaly detection model 110 using the data pertaining to activities 126 of the user 122. However, based on a determination that there is insufficient data 132 pertaining to activities 126 of the user 122, the processor may train the anomaly detection model 110 using data 132 pertaining to activities of multiple users.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. An apparatus comprising:
a processor; and
a memory on which is stored machine-readable instructions that when executed by the processor, cause the processor to:
identify a timing at which a user activity occurred;
apply an anomaly detection model on the identified timing at which the user activity occurred, wherein the anomaly detection model is to output a risk score corresponding to a deviation of the timing at which the user activity occurred from timings at which the user normally performs user activities;
determine whether the timing at which the user activity occurred is anomalous based on the risk score; and
based on a determination that the timing at which the user activity occurred is anomalous, output an alert regarding the anomalous timing of the user activity occurrence.

2. The apparatus of claim 1, wherein the timings at which the user normally performs the user activity comprises a time period during which the user historically performs work duties for an organization.

3. The apparatus of claim 1, wherein the anomaly detection model is trained using data collected pertaining to activities of the user.

4. The apparatus of claim 3, wherein the data collected pertaining to the activities of the user comprises data collected across multiple data sources, wherein the multiple data sources comprise a data source that tracks access to a cloud environment, a data source that tracks login events to resources, and/or a data source that tracks access to foes.

5. The apparatus of claim 3, wherein the instructions cause the processor to:
train the anomaly detection model using the data collected pertaining to activities of the user.

6. The apparatus of claim 1, wherein the anomaly detection model is trained using data collected pertaining to activities of multiple users.

7. The apparatus of claim 6, wherein the instructions cause the processor to:
train the anomaly detection model using the data collected pertaining to activities of the multiple users.

8. The apparatus of claim 1, wherein the instructions cause the processor to:
determine whether there is sufficient data collected pertaining to activities of the user for the anomaly detection model to be trained to output the risk score within a predefined level of precision;
based on a determination that there is sufficient data, apply an anomaly detection model that is trained using data collected pertaining to activities of the user to determine the risk score; and
based on a determination that there is insufficient training data, apply an anomaly detection model that is trained using data collected pertaining to activities of multiple other users to determine the risk score.

9. The apparatus of claim 8, wherein the multiple other users comprise other users within an organization to which the user belongs or other users within a department of the organization to which the user is a member.

10. A method comprising:
identifying, by a processor, a timing at which a user activity occurred;
applying, by the processor, an anomaly detection model on the identified timing at which the user activity occurred, wherein the anomaly detection model is to take the identified timing as an input and to output a risk score of the timing at which the user activity occurred corresponding to a deviation of the timing of the user activity occurrence from timings of normal user activities;
determining, by the processor, whether the risk score of the timing exceeds a predefined threshold score; and
based on the risk score of the timing exceeding the predefined threshold score, outputting, by the processor, an alert regarding an abnormal timing of the user activity occurrence.

11. The method of claim 10, wherein the timings of normal user activities comprise time periods during which the user historically performs work duties for an organization to which the user is a member.

12. The method of claim 10, further comprising:
accessing data collected across multiple data sources;
training the anomaly detection model using the accessed data; and
applying the trained anomaly detection model on the identified timing.

13. The method of claim 12, wherein the data collected across the multiple data sources comprise data pertaining to activities of the user.

14. The method of claim 12, wherein the data collected across the multiple data sources comprise data pertaining to activities of multiple users.

15. The method of claim 12, further comprising:
determining whether there is sufficient data collected pertaining to activities of the user for the anomaly detection model to be trained to output the risk score within a predefined level of precision;
based on a determination that there is sufficient data pertaining to activities of the user, training the anomaly detection model using the data pertaining to activities of the user; and
based on a determination that there is insufficient data pertaining to activities of the user, training the anomaly detection model using data pertaining to activities of multiple users.

16. The method of claim 15, further comprising:
based on a determination that there is sufficient training data pertaining to activities of the user, applying the anomaly detection model trained using the training data pertaining to activities of the user on the identified timing; and
based on a determination that there is insufficient training data pertaining to activities of the user, applying the anomaly detection model trained using the training data pertaining to activities of the multiple users.

17. The method of claim 15, wherein the multiple users comprise other users within an organization to which the user is a member or other users within a department of the organization to which the user is a member.

18. A computer-readable medium on which is stored computer-readable instructions that when executed by a processor, cause the processor to:
access information pertaining to a timing at which a user activity on a computing device occurred;
apply an anomaly detection model on the timing at which the user activity on the computing device occurred, wherein the anomaly detection model is to take the identified timing as an input and to output a risk score of the timing at which the user activity occurred corresponding to a deviation of the timing of the user activity occurrence from timings during which the user historically performs work duties of an organization to which the user is a member;
determine whether the risk score of the timing exceeds a predefined threshold score; and
based on the risk score of the timing exceeding the predefined threshold score, output an alert regarding the risk score of the timing of the user activity occurrence.

19. The computer-readable medium of claim 18, wherein the instructions further cause the processor to:
access data collected across multiple data sources;
train the anomaly detection model using the accessed data; and
apply the trained anomaly detection model on the timing at which the user activity on the computing device occurred.

20. The computer-readable medium of claim 19, wherein the instructions further cause the processor to:
determine whether there is sufficient data pertaining to activities of the user for the anomaly detection model to be trained to output the risk score within a predefined level of precision;
based on a determination that there is sufficient data pertaining to activities of the user, train the anomaly detection model using the data pertaining to activities of the user; and
based on a determination that there is insufficient data pertaining to activities of the user, train the anomaly detection model using data pertaining to activities of multiple users.
